(19) United States
(12) Patent Application Publication
(10) Pub. No.: US 2013/0335318 A1
(43) Pub. Date: Dec. 19, 2013

(54) METHOD AND APPARATUS FOR DOING HAND AND FACE GESTURE RECOGNITION USING 3D SENSORS AND HARDWARE NON-LINEAR CLASSIFIERS

(71) Applicant: Cognimem Technologies, Inc., Folsom, CA (US)

(72) Inventors: Bill H. Nagel, Folsom, CA (US); Chris J. McCormick, Santa Barbara, CA (US); K. Avinash Pandey, Folsom, CA (US)

(21) Appl. No.: 13/917,031

(22) Filed: Jun. 13, 2013

Related U.S. Application Data
(60) Provisional application No. 61/660,583, filed on Jun. 15, 2012.

(51) Int. Cl. G06F 3/01

(52) U.S. Cl. CPC G06F 3/017
USPC 345/156

(57) ABSTRACT

A method of controlling a mobile or stationary terminal comprising of the steps of one of multiple ways for 3D sensing a hand or face, recognizing the visual command input by trained hardware that does not incorporate instruction based programming and then causing some useful function to be performed by the recognized gesture on the terminal. This method is to enhance gross body gesture recognition in practice today. Gross gesture recognition has been made accessible by providing accurate skeleton tracking information down to the location of a person's hands or head. Notably missing from the skeleton tracking data, however, are the detailed positions of the person's fingers or facial gestures. Recognizing the arrangement of the fingers on a person's hand or expression on his or her face has applications in recognizing gestures such as sign language, as well as user inputs that are normally done with a mouse or a button on a controller. Tracking individual fingers or the subtleties of facial expressions poses many challenges, including the resolution of the depth camera, the possibility for fingers to occlude each other, or be occluded by the hand and performing these functions within the power and performance limitations of traditional coded architectures. This unique codeless, trainable hardware method can recognize finger gestures robustly and deal with these limitations. By recognizing facial expressions, additional information like approval, disapproval, surprise, commands and other useful inputs can be incorporated.

### TECHNICAL FIELD

The present disclosure relates to a method for controlling a mobile or stationary terminal via a 3D sensor and a codeless hardware recognition device integrating a non-linear classifier with or without a computer program assisting such a method. Specifically, the disclosure relates to facilitating hand or face gesture user input using one of multiple types (structured light, time-of-flight, stereoscopic, etc.) of 3D image input and a patented and unique class of hardware implemented non-linear classifiers.

### BACKGROUND

Present day mobile and stationary terminal devices such as mobile phones or gaming platforms are equipped with image and/or IR sensors and are connected to display screens that display user input or the user him/herself in conjunction with a game or application being performed by the terminal. Such an arrangement is typically configured to receive input by interaction with a user through a user interface. Currently such devices are not controlled by specific hand (like American Sign Language for instance) or facial gestures being processed by a zero instruction based hardware non-linear classifier (codeless). This proposed approach to solving the problem results in a low power and real time implementation which can be made very inexpensive for implementation into wall powered and/or battery operated platforms for industrial, military, commercial, medical, automotive, consumer applications and more.

One current popular system uses gesture recognition with an RGB camera and an IR depth field camera sensor to compute skeletal information and translate to interactive commands for gaming for instance. This embodiment introduces an additional hardware capability that can take real time information of the hands and/or the face and give the user a new level of control for the system. This additional control could be using the index finger and motioning it for a mouse click, using the thumb and index finger to show expansion or contraction or an open hand becoming a closed hand to grab for instance. These recognized hand inputs can be combined with tracking of the hand's location to perform operations such as grabbing and manipulating virtual objects or drawing shapes or freeform images that are also recognized real time by the hardware classifier in the system, greatly expanding the breadth of applications that the user can enjoy and the interpretation of the gesture itself.

Secondarily, 3D information can be obtained in other ways—such as time of flight or stereoscopic input. The most cost effective way is to use stereoscopic vision sensor input only and triangulate the distance based on the shift of pixel information from the right and left cameras. Combining this with a nonlinear hardware implemented classifier can not only provide direct translation of depth of an object, but recognition of the object as well. These techniques versus instruction based software simulation will allow for significant cost, power, size, weight, development time and latency reduction allowing a wide range of pattern recognition capability in mobile or stationary platforms.

The hardware nonlinear classifier is a natively implemented radial basis function (RBF) Restricted Coulomb Energy (RCE) learning function and/or kNN (k nearest neighbor) machine learning device that can take in vectors (data bases)—compare in parallel against internally stored vectors, apply a threshold function against the result and then search and sort on the output for winner take all recognition decision, all without code execution. This technique implemented in silicon is covered by U.S. Pat. Nos. 5,621,863, 5,717,832, 5,701,397, 5,710,869 and 5,740,326. Specifically applying a device covered by these patents to solve hand/face gesture recognition from 3D input is the substance of this application.

A system can be designed using 3D input with simulations of various algorithms run on traditional CPUs/GPUs/DSPs to recognize the input. The problem with these approaches is that it requires many cores and/or threads to perform the function within the latency required. For real time interaction and to be accurate—many models must be looked at simultaneously. This makes the end result cost & power prohibitive for consumer platforms in particular. By using a natively implemented massively parallel memory based hardware nonlinear classifier referred to above, this is mitigated to a practical and robust solution for this class of applications. It becomes practical for real time gesturing for game interaction, sign language interpretation, and computer control on hand held battery appliances via these techniques. Because of low power recognition, applications such as instant on when a gesture or face is recognized can also be incorporated into the platform. A traditionally implemented approach would consume too much battery power to continuously be looking for such input.

The lack of finger recognition in current gesture recognition gaming platforms create a notable gap in the abilities of the system as compared to other motion devices which incorporate buttons. For example there is no visual gesture option for quickly selecting an item, or for doing drag-and-drop operations. Game developers have designed games for systems around this omission by focusing on titles which recognize overall body gestures, such as dancing and sports games. As a result, there exists an untapped market of popular games which lend themselves to motion control but require the ability to quickly select objects or grab, reposition, and release them. Currently this is done with a mouse input or buttons.

### SUMMARY OF AN EXAMPLE EMBODIMENT

An object of this embodiment is to overcome at least some of the drawbacks relating to the compromise designs of prior art devices as discussed above. The ability to click on objects as well as to grab, re-position, and release objects is also fundamental to the user-interface of a PC. Performing drag-and-drop on files, dragging scrollbars or sliders, panning document or map viewers, and highlighting groups of items are all based on the ability to click, hold, and release the mouse.

Skeleton tracking of the overall body has been implemented successfully by Microsoft and others. One open source implementation identifies the joints by converting the depth camera data into a 3D point cloud, and connecting adjacent points within a threshold distance of each other into coherent objects. The human body is then represented as a collection of 3D points, and appendages such as the head and hands can be found as extremities on that surface. To match the extremities to their body parts, the proportions of the human body are used to determine which arrangement of the extremities best matches the expected proportions of the human body. A similar approach could theoretically be applied to the hand to identify the location of the fingers and their joints; however, the depth camera may lack the resolution and precision to do this accurately.

To overcome the coarseness of the fingers in the depth view, we will use hardware based pattern matching to recognize the overall shape of the hand and fingers. The silhouette of the hand will be matched against previously trained examples in order to identify the gesture being made.

The use of pattern matching and example databases is common in machine vision. An important challenge to the approach, however, is that accurate pattern recognition can require a very large database of examples. The von Neumann architecture is not well suited to real-time, low-power pattern matching; the examples must be checked in serial, and the processing time scales linearly with the number of examples to check. To overcome this, we will demonstrate pattern matching with the CogniMem CM1K (or any variant covered by the aforementioned patents) pattern matching chip. The CM1K is designed to perform pattern matching in full parallel, and simultaneously compares the input pattern to every example in its memory with a response time of 10 microseconds. Each CM1K stores 1024 examples and multiple CM1Ks can be used in parallel to increase the database size without affecting response time. Using the CM1K, the silhouette of the hand can be compared to a large database of examples in real-time and low-power.

### Hand Extraction

The skeleton tracking information helps identify the coordinate of the hand joint within the depth frame. We first take a small square region around the hand from the depth frame, and then exclude any pixels which are outside of a threshold radius from the hand joint in real space. This allows us to isolate the silhouette of the hand against a white background, even when the hand is in front of the person's body (provided the hand is at least a minimum distance from the body). See FIG. 7.

### Training the CM1K

Samples of the extracted hand are recorded in different orientations and distances from the camera (FIG. 8). The CM1K implements two non-linear classifiers which we train on the input examples. As we repeatedly train and test the system, more examples are gathered to improve its accuracy. Recorded examples are categorized by the engineer, and shown to the chip to train it.

The chip uses patented hardware implemented Radial Basis Function (RBF) and Restricted Coulomb Energy (RCE) or k Nearest Neighbor (kNN) algorithms to learn and recognize examples. For each example input, if the chip does not yet recognize the input, the example is added to the chip's memory (that is, a new “neuron” is committed) and a similarity threshold (referred to as the neuron's “influence field”) is set. The example stored by a neuron is referred to as the neuron's model.

Inputs are compared to all of the neurons (collectively referred to as the knowledge base) in parallel. An input is compared to a neuron's model by taking the Manhattan (L1) distance between the input and the neuron model. If the distance reported by a neuron is less than that neuron's influence field, then the input is recognized as belonging to that neuron's category.

If the chip is shown an image which it recognizes as the wrong category during learning, then the influence field of the neuron which recognized it is reduced so that it no longer recognizes that input.

An example implementation of the invention can consist of a 3D sensor, a television or monitor, and a CogniMem hardware evaluation board, all connected to a single PC (or other computing platform). Software on the PC will extract the silhouette of the hand from the depth frames and will communicate with the CogniMem board to identify the hand gesture.

The mouse cursor on the PC will be controlled by the user's hand, with clicking operations implemented by finger gestures. A wide range of gestures can be taught—like the standard American sign language or user defined hand/face gestures. Example gestures of user input, including the ability to click on objects, grab and reposition objects, pan and zoom in or out on the screen are appropriate for this example implementation. The user will be able to use these gestures to interact with various software applications, including both video games and productivity software.

The present embodiment now will be described more fully hereinafter with reference to the accompanying drawings, in which some examples of the embodiments are shown. Indeed, these may be represented in many different forms and should not be construed as limited to the embodiments set forth herein; rather, these embodiments are provided by way of example so that this disclosure will satisfy applicable legal requirements.

### BRIEF DESCRIPTION OF THE DRAWINGS

FIG. 1 shows schematically a block diagram of a system incorporating a hand or face expression recognition (RBF/RCE,kNN) hardware device (104) with inputs from an RGB sensor (101) and an IR sensor (102) through a CPU (103). Images and/or video and depth field information is retrieved by the CPU from the sensors, processed to extract the hand, finger or face and then the preprocessed information is sent to the RBF/RCE/kNN (105—can be wired or wireless connection) hardware accelerator (specifically a neural network, nonlinear classifier) for recognition. The results of the recognition are then reported back to the CPU (103).

FIG. 2 is a flow chart illustrating a number of steps of a method to recognize hand or facial expression gestures using the RBF/RCE, kNN hardware technology according to one embodiment. Functions in (201) are performed by the CPU prior to the CPU transferring the information to the RBF/RCE, kNN hardware accelerator for either training (offline, or real-time) or recognition (202). Steps (203), (204) or (205), (206) are performed in hardware by the accelerator whether in learning (training) or recognition respectively.

FIG. 3 shows schematically a block diagram of a system incorporating a hand or face expression recognizer hardware (304) with inputs from two CMOS sensors (301), (302) through a CPU (303). The diagram in FIG. 3 operates the same as FIG. 1, except the 3D depth information is obtained through stereoscopic comparison of the 2 or more CMOS sensors.

FIG. 4 is a flow chart illustrating a number of steps of a method to recognize hand gestures using the RBF/RCE, kNN hardware technology according to another embodiment. This flow chart is the same as FIG. 2, except the 3D input comes from 2 or more CMOS sensors (FIG. 3. (301), (302)) for the depth information (stereoscopic).

FIG. 5 shows schematically a block diagram of a system incorporating RBF/RCE, kNN hardware technology directly connected to the sensors. In this configuration, the hardware accelerator (RBF/RCE, kNN) performs some if not all of the “pre-processing” steps that were previously done by instructions on a CPU. The hardware accelerator can be generating feature vectors from the images directly and then learning and recognizing the hand, finger or face (or facial feature) gestures from these vectors as an example. This can occur as single or multiple passes through the hardware accelerator, controlled by local logic or instructions run on the CPU. For instance—instead of the CPU mathematically scaling the image, the hardware accelerator can learn different sizes of the hand, finger or face (or feature of the face). The hardware accelerator could also learn and recognize multiple positions of the gesture versus the CPU performing this function as a preprocessed rotation.

FIG. 6 is a flow chart illustrating a number of steps for doing the gesture/face expression learning and recognition directly from the sensors. In FIG. 6, the hardware accelerator performs one or many of the steps in (601) as well as the steps listed in (603), (604), (605), (606) similar to the other configurations.

FIG. 7 As an example, the hand is isolated from its surroundings using the depth data by the CPU or the hardware accelerator.

FIG. 8 Small subset of extracted hand samples used to train the chip on an open hand. During learning, only samples which the chip doesn't already recognize will be stored as new neurons. During recognition, the hand information (as example) coming from the sensors is compared to the previously trained hand samples to see if there is a close enough match to recognize the gesture (open hand gesture shown).

FIG. 9 An example of extracting a sphere of information around a hand (or finger, face not shown) and using this information for recognizing the gesture being performed.

### DETAILED DESCRIPTION

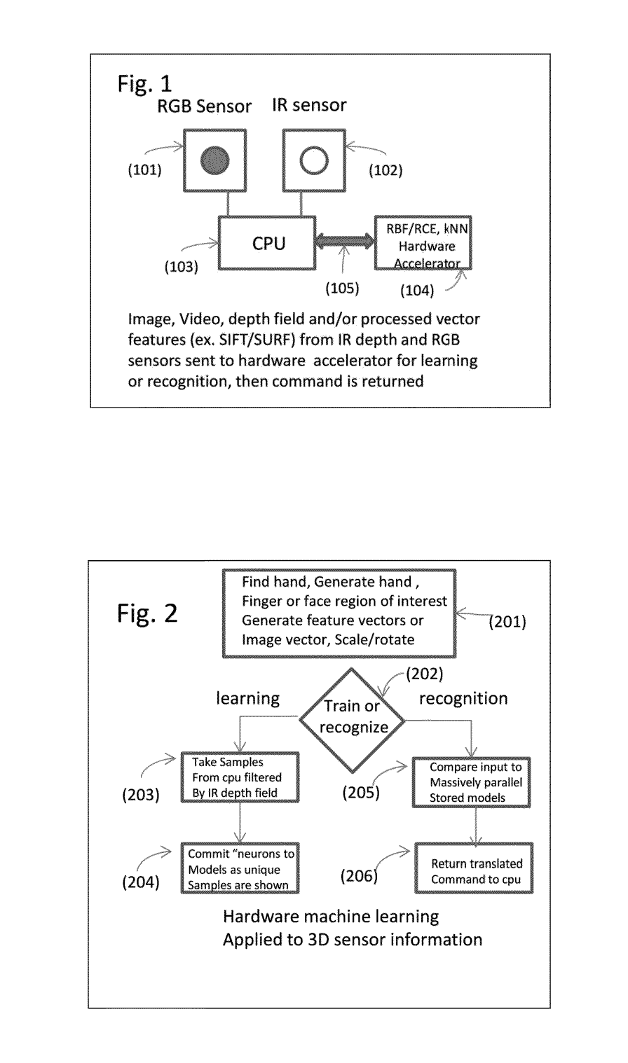

FIG. 1 illustrates a general purpose block diagram of a 3D sensing system including a RGB sensor (FIG. 1 (101)) and an IR sensor (FIG. 1 (102)) that are connected to a CPU (FIG. 1 (103)—or any DSP, GPU, GPGPU, MCU etc. or combination thereof) and a hardware accelerator for the gesture recognition (FIG. 1 (104)) through a USB, I2C, PCIe, local bus, any Parallel, serial or wireless interface to the processor (FIG. 1 (103)) wherein the processor is able to process the information from the sensors and use the hardware accelerator to do the classification on the processed information. An example of doing this is using the depth field information from the sensor and identify the body mass. From this body mass, one can construct a representative skeleton of the torso, arms and legs. Once this skeletal frame is created, the embodied system can determine where the hand is located. The CPU determines the location of the hand joint, getting XYZ coordinates of the hand or palm (and/or face/facial features) extracting the region of interest by taking a 3D “box or sphere”—say 128×128 pixels×depth field—and going through all pixels asking what 3D coordinates for each pixel are at any point capturing only those within 6 inches (as an example for the hand) in the sphere. This then captures only the feature(s) of interest and eliminates the non-relevant background information enhancing the robustness of the decision. (see FIG. 9.) The extracted depth field information may then be replaced (or not) with a binary image to eliminate variations in depth or light information (from RGB)—giving only the shape of the hand. The image is centered in the screen and scaled to be comparable to the learned samples that are stored. Many samples are used and trained for different positions (rotation) of the gesture The software instructions of the CPU to perform this function may be stored in its instruction memory through normal techniques in practice today. Any type of conventional removable and or local memory is also possible, such as a diskette, a hard drive, a semi-permanent storage chip such as a flash memory card or “memory stick” etc. for storage of the CPU instructions and the learned examples of the hand and or facial gestures.

In summary, the CPU (FIG. 1 (103)) takes the extracted image as described in FIG. 2 flow diagram (FIG. 2 (201)) and performs these various pre-processing functions on the image—such as scaling, background elimination, feature extraction (another example: SIFT/SURF feature vector creation) and sends the resulting image, video and possibly depth field information or feature vectors to the hardware classifier accelerator (FIG. 1 (104)) for training during the learning phase (FIG. 2 (202,203,204)) or recognition (FIG. 2 (202, 205,206)) of command during the recognition phase. During the learning phase, the hardware accelerator (FIG. 1 (104)) determines if previously learned examples, if any, are sufficient to recognize the new sample. If not, new neurons are committed in hardware (FIG. 1 (104)) to represent these new samples (FIG. 2 (204)). Once learned the hardware (FIG. 1 (104)) can be placed in recognition mode (FIG. 2 (202)) wherein new data is compared to learned samples in parallel (FIG. 2. (205)), recognized and translated to a category (command) to convey back to the CPU (FIG. 2 (206)).

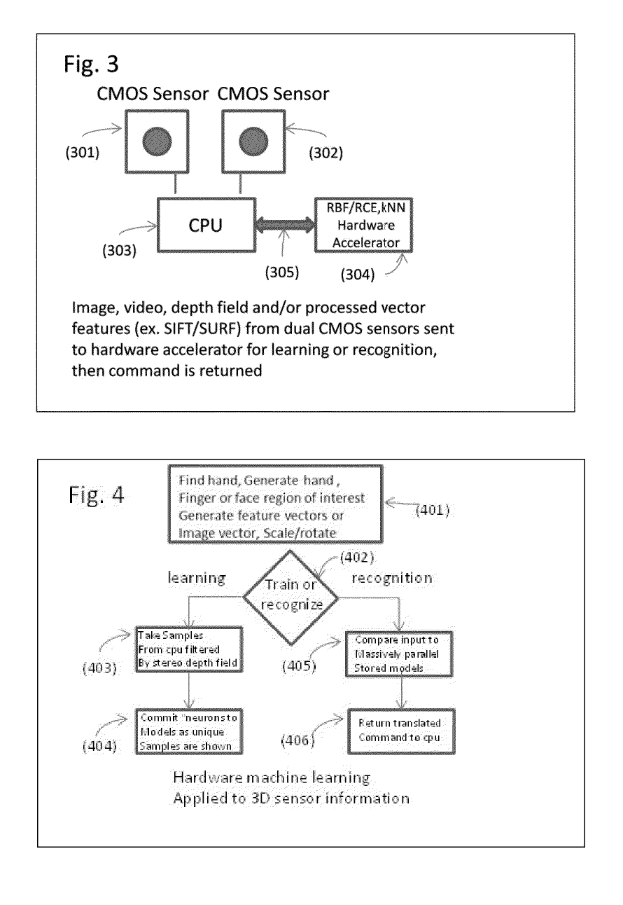

FIGS. 3 and 4 describe a similar sequence, however a structured light sensor for depth information is not used but alternatively a set of 2 or more stereoscopic CMOS sensors (FIG. 3 (301) & (302)) are used. The depth information is obtained by comparing the shifted pixel images and determining the degree of shift of the recognized pixel between the two images and triangulating the distance to the common feature of the two images with a known fixed distance between the cameras. The CPU (FIG. 3 (303)) performs this comparison. The resulting depth information is then used in a similar manner above to identify the region of interest and perform the recognition as outlined in FIG. 4 and by the hardware accelerator (FIG. 3 (304)) connected by a parallel, serial or wireless bus (FIG. 3 (303)).

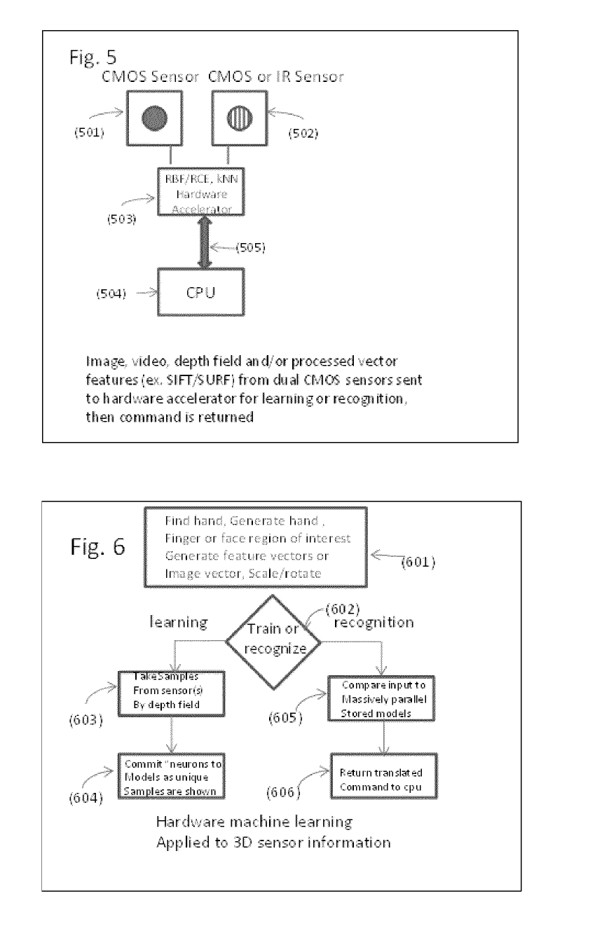

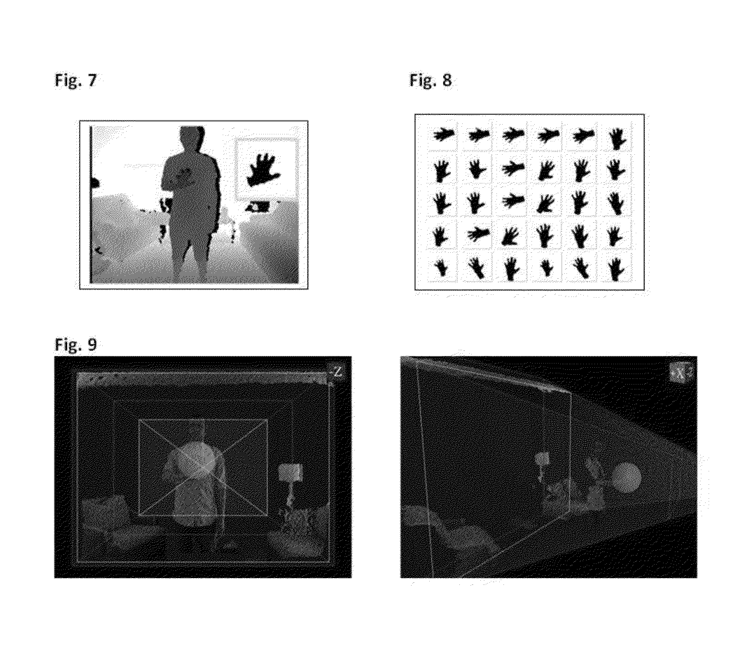

FIGS. 5 and 6 describe a combination of the above sensor configurations but the hardware accelerator (FIG. 5 (503)) performs any or all of the above CPU (or DSP, GPU, GPGPU, MCU) functions (FIG. 6 (601) by using neurons for scaling, rotation, feature extraction (ex. SIFT/ SURF), depth determination in addition to the functions listed in FIG. 6 (602, 603, 604, 605 and 606) that were performed by the hardware accelerator as described above (FIGS. 1,2 & FIGS. 3,4). This is can also be done with assistance by the CPU (or other) for housekeeping, display management etc. An FPGA may also be incorporated into any or all of the above diagrams for interfacing logic or handling some of the preprocessing functions described herein.

Many modifications and other embodiments versus those set forth herein will come to mind to one skilled in the art to which these embodiments pertain having the benefit of the teachings presented in the foregoing descriptions and the associated drawings. Therefore, it is to be understood that the specific examples of the embodiments disclosed are not exhaustive and that modifications and other embodiments are intended to be included within the scope of the appended claims. Although specific terms are employed herein, they are used in a generic and descriptive sense only and not for purposes of limitation.

What is claimed is:

1. A method for gesture controlling a mobile or stationary terminal comprising a 3D visual and depth sensor using structured light, or multiple stereoscopic image sensors (3D), the method comprising the steps of: sensing a hand or face as a portion of the input, isolating these body parts and interpreting the motion gesture or expression being made through a codeless hardware device directly implementing non-linear classifiers to command the terminal to perform a function, similar to a mouse, touch or keyboard entry.

2. The method according to claim 1, wherein the hardware based nonlinear classifier takes SIFT (Scale Invariant Feature Transform) and/or SURF (Speeded Up Robust Features) vectors created by a CPU from an RGB image sensor and/or IR depth sensor and compares to a learned data base for recognition real time of the visual hand or face command to command the terminal to perform a function.

3. The method according to claim 1, wherein the hardware based nonlinear classifier takes the actual image or depth field output from an RGB sensor and/or IR depth sensor via a CPU or other controller and compares this direct pixel information to a learned data base for recognition real time of the visual hand or face command to command the terminal to perform a function.

4. The method according to claim 1, wherein the hardware based nonlinear classifier takes the actual image or depth field output from an RGB sensor and/or IR depth sensor via a CPU or other controller and generates either SIFT or SURF vectors from the pixel data then compares these vectors to a learned data base for recognition real time of the visual hand or face command to command the terminal to perform a function.

5. The method according to claim 1, wherein the hardware based nonlinear classifier takes SIFT and/or SURF vectors created by a CPU from two CMOS image sensors creating a stereo image and compares these vectors to a learned data base for recognition real time of the visual hand or face command to command the terminal to perform a function.

6. The method according to claim 1, wherein the hardware based nonlinear classifier takes the actual image or depth field output from two stereoscopic CMOS image sensors, via a CPU or other controller, extracts the depth information and compares this extracted and/or direct pixel information to a learned data base for recognition real time of the visual hand or face command to command the terminal to perform a function.

7. The method according to claim 1, wherein the hardware based nonlinear classifier takes the actual image or depth field output from the two CMOS image sensors, via a CPU or other controller, and generates either SIFT or SURF vectors from the pixel data then compares these vectors to a learned data base for recognition real time of the visual hand or face command to command the terminal to perform a function.

8. A system where there is no CPU or encoded instruction processing unit directly connected with the sensors and the output of the RGB sensor and IR depth sensor are directed into the hardware based non-linear classifier. This configuration which may also include external memory and an FPGA, wherein the hardware based nonlinear classifier takes the image information and directly recognizes the hand or face gesture and commands the terminal CPU to perform a function.

9. A system where there is no CPU or encoded instruction processing unit with the sensors and the output of the two CMOS image sensors (stereoscopic for depth) are directed into the hardware based non-linear classifier which may also include external memory and an FPGA, wherein the hardware based nonlinear classifier takes the image information and directly recognizes the hand or face gesture and commands the terminal cpu to perform a function.
